(19) United States
(12) Patent Application Publication
(10) Pub. No.: US 2015/0015080 A1
(43) Pub. Date: Jan. 15, 2015

(54) POWER TRANSMISSION APPARATUS AND COIL DEVICE

(71) Applicant: TOSHIBA TEC KABUSHIKI KAISHA, Tokyo (JP)

(72) Inventors: Masakazu Kato, Numazu-shi (JP); Masahiro Kanagawa, Mishima-shi (JP)

(21) Appl. No.: 14/328,854

(22) Filed: Jul. 11, 2014

(30) Foreign Application Priority Data
Jul. 12, 2013 (JP) 2013-146817

(51) Int. Cl. H01F 38/14; H04B 5/00

(52) U.S. Cl. CPC H01F 38/14; H04B 5/0037
USPC 307/104; 336/115

(57) ABSTRACT

In a power transmission apparatus which transmits power from a power transmission device to a power reception device in a noncontact manner through electromagnetic coupling, the power transmission device includes a power transmission coil, and an AC power source supplying AC power to a resonance element including the power transmission coil. The power reception device includes a power reception coil that receives power, and a rectifying circuit rectifying AC power induced in a resonance element including the power reception coil. One of the power transmission coil and the power reception coil includes a blank region formed at a central portion, and a first coil pattern formed in a planar shape at a peripheral portion of the blank region, and the other of the power transmission coil and the power reception coil includes a second coil pattern formed in a planar shape so as to correspond to the blank region.

### CROSS-REFERENCE TO RELATED APPLICATION

This application is based upon and claims the benefit of priority from Japanese Patent Application No. 2013-146817, filed Jul. 12, 2013, the entire contents of which are incorporated herein by reference.

### FIELD

Embodiments described herein relate generally to a power transmission apparatus which transmits power from a power transmission device to a power reception device in a noncontact manner, and a coil device.

### BACKGROUND

In recent years, an apparatus which transmits power in a noncontact manner is widely spread. A power transmission apparatus includes a power transmission device which transmits power, and a power reception device which receives the transmitted power. The power transmission apparatus transmits power from the power transmission device to the power reception device in a noncontact manner by using an electromagnetic induction system, a magnetic field resonance system, an electric field coupling method, or the like. The power reception device includes a driving circuit which drives the power reception device, and a load circuit such as a charging circuit of a secondary battery mounted in the power reception device.

When power is transmitted to an electronic apparatus such as a portable terminal or a notebook PC in a noncontact manner, if the electromagnetic induction system or the electric field coupling method is used, the power transmission device and the power reception device are generally required to be substantially brought into close contact with each other in a transmittable region. On the other hand, if the magnetic field resonance system is used, the power transmission device and the power reception device are not required to be brought into close contact with each other, and, for example, even if the power reception device is separated from the power transmission device at about several cm, power can be transmitted. Therefore, the magnetic field resonance system attracts attention since there is a degree of freedom at a position where the power reception device is placed, and convenience is excellent.

In the magnetic field resonance system, a resonance element formed by a coil and a capacitor provided in a power transmission device and a resonance element formed by a coil and a capacitor provided in a power reception device are coupled with each other, and thus power can be transmitted. Even in the electromagnetic induction system, a trial was made to increase a power transmission distance not only by coupling a coil of a power transmission side and a coil of a power reception side with each other but also by providing resonance capacitors in both the power transmission side and the power reception side so as to resonantly couple elements of the power transmission side and the power reception side with each other. Therefore, differentiation between the magnetic field resonance system and the electromagnetic induction system disappears.

In addition, as a parameter which influences power transmission efficiency, there is a coupling coefficient k between resonance elements of a power transmission device and a power reception device. If a distance between the resonance elements of the power transmission device and the power reception device varies, the coupling coefficient k also typically varies. For example, if a distance between the resonance elements increases, the coupling coefficient k decreases. If the impedance of a circuit is fixed, the power transmission efficiency or transmittable power varies according to a variation in the coupling coefficient k.

As a method of maintaining the power transmission efficiency to be high even if the coupling coefficient k varies according to a variation in a distance between the resonance elements of the power transmission device and the power reception device, there is a technique in which an impedance adjusting unit which can vary impedance is provided, and impedance of the power transmission device or the power reception device is varied according to a variation in the coupling coefficient k (refer to JP-A-2011-50140).

However, in the technique disclosed in JP-A-2011-50140, there is a problem in that a new circuit for automatically controlling impedance is necessary when the coupling coefficient k varies, and control is complex.

Meanwhile, as a device which can transmit power even if positions of a power transmission coil and a power reception coil deviate from each other, there is a noncontact charging device in which a large diameter coil is used as the power transmission coil, and a small diameter coil is used as the power reception coil (refer to JP-A-2008-301553).

However, in an example disclosed in JP-A-2008-301553, if a position of the power reception coil deviates relative to the power transmission coil in a vertical direction, and thus a distance between the power transmission coil and the power reception coil is lengthened, there is a problem in that a coupling coefficient k rapidly decreases, power transmission efficiency deteriorates, and thus desired power cannot be transmitted.

### DESCRIPTION OF THE DRAWINGS

FIG. 1 is a circuit block diagram illustrating a configuration of a power transmission apparatus according to an embodiment.

FIG. 2 is a perspective view.

FIGS. 3A and 3B are respectively a perspective view and a plan view schematically illustrating a coil device including a power transmission coil and a power reception coil.

FIGS. 4A and 4B are cross-sectional views illustrating a positional relationship between a power transmission device and a power reception device.

FIGS. 5A and 5B are cross-sectional views illustrating another positional relationship.

FIGS. 6A and 6B are plan views illustrating a shape of the coil device and an example of dimensions.

FIG. 7 is a plan view illustrating a power reception coil of a general power transmission apparatus.

FIG. 8 is a diagram illustrating a measurement system of a coupling coefficient k in the power transmission apparatus according to the embodiment.

FIG. 9 is a characteristic diagram illustrating a relationship between a distance between transmission and reception coils and a coupling coefficient k in the embodiment and a general example.

FIGS. 10A and 10B are cross-sectional views illustrating a positional relationship between coil patterns of a general power transmission coil and a power reception coil.

FIGS. 11A and 11B are cross-sectional views illustrating a positional relationship between coil patterns of the power transmission coil and the power reception coil according to the embodiment.

FIG. 12 is a plan view illustrating a state in which the power reception coil is horizontally moved.

FIG. 13 is a characteristic diagram illustrating a relationship between a horizontal direction deviation amount and a coupling coefficient k in the embodiment and a general example.

FIGS. 14A and 14B are plan views comparatively illustrating a square coil and a circular coil.

FIG. 15 is a perspective view illustrating a configuration of a power transmission apparatus according to a second embodiment.

### DETAILED DESCRIPTION

The embodiments are to provide a noncontact power transmission apparatus which minimizes a variation in a coupling coefficient k even if a position of a power reception coil varies relative to a power transmission coil, and a coil device.

According to an embodiment, there is a power transmission apparatus including a power transmission device that transmits power in a noncontact manner through electromagnetic coupling; and a power reception device that receives the power, in which the power transmission device includes a power transmission coil; and an AC power source that supplies AC power to a resonance element including the power transmission coil, in which the power reception device includes a power reception coil that receives power; and a rectifying circuit that rectifies AC power induced in the a resonance element including the power reception coil, in which one of the power transmission coil and the power reception coil includes a blank region that is formed at a central portion, and a first coil pattern that is formed in a planar shape at a peripheral portion of the blank region, and in which the other of the power transmission coil and the power reception coil includes a second coil pattern which is formed in a planar shape so as to correspond to the blank region.

Hereinafter, embodiments will be described with reference to the drawings. In addition, the same constituent elements are given the same reference numerals throughout all the drawings.

### First Embodiment

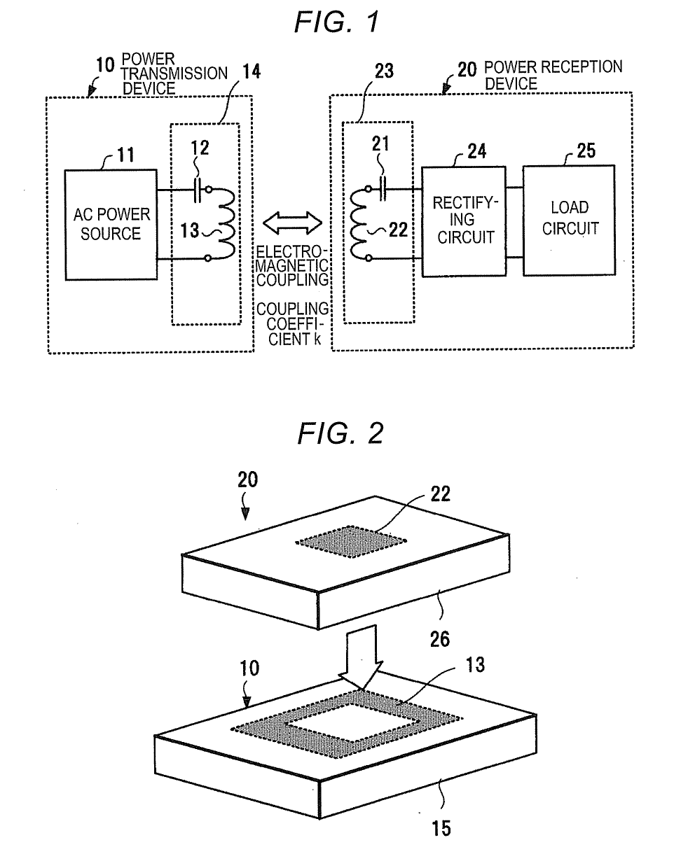

FIG. 1 is a circuit block diagram illustrating an entire configuration of a power transmission apparatus according to a first embodiment. FIG. 2 is a perspective view schematically illustrating a power transmission device and a power reception device forming the power transmission apparatus. As illustrated in FIG. 1, the power transmission apparatus includes a power transmission device 10 which transmits power, and a power reception device 20 which receives the transmitted power. The power transmission device 10 and the power reception device 20 transmit power in a system using electromagnetic coupling, such as a magnetic field resonance system or an electromagnetic induction system. Hereinafter, description will be made of a case where power is transmitted in the magnetic field resonance system or the electromagnetic induction system.

The power transmission device 10 includes an AC power source 11 which generates power, and a resonance element 14 formed by a resonance capacitor 12 and a power transmission coil 13. The AC power source 11 generates AC power of the same or substantially the same frequency as a self resonance frequency of the resonance element 14 for transmitting power, and supplies the AC power to the resonance element 14. The AC power source 11 includes an oscillation circuit which generates AC power of a desired frequency, and a power amplification circuit which amplifies an output of the oscillation circuit. Alternatively, the AC power source 11 may have a configuration of a switching power source, and may turn on and off switching elements by using an output of an oscillation circuit.

In addition, DC power is supplied to the AC power source 11 from an AC adaptor or the like which is provided outside the power transmission device 10. Alternatively, DC power may be supplied to the AC power source 11 by supplying AC 100 V to the power transmission device 10 from an external device, and providing an AC adaptor or an AC/DC conversion unit in the power transmission device 10.

The power reception device 20 includes a resonance element 23 formed by a resonance capacitor 21 and a power reception coil 22, a rectifying circuit 24 which converts DC into AC, and a load circuit 25. A self resonance frequency of the resonance element 23 for receiving power is the same or substantially the same as the self resonance frequency of the resonance element 14 for transmitting power, and the resonance elements 23 and 24 are electromagnetically coupled with each other, so that power is efficiently transmitted from the power transmission side to the power reception side.

The load circuit 25 is a circuit of an electronic apparatus such as a portable terminal or a tablet terminal, and power received by the power reception device 20 is used to operate the electronic apparatus or to charge a battery built into the electronic apparatus. Generally, the load circuit 25 is operated by DC power. In order to supply DC power to the load circuit 25, the rectifying circuit 24 is provided which rectifies AC power induced in the resonance element 23 for receiving power so as to convert the AC power into DC power.

In addition, the resonance capacitors 12 and 21 are not necessarily required to be formed by electronic components, and may use the inter-line capacitance of a coil or the like depending on a shape of the coil or an inductance value of the coil. Further, the resonance capacitor 12 is disposed in series with the power transmission coil 13, and the resonance capacitor 21 is disposed in series with the power reception coil 22, so as to form a serial resonance circuit, but the respective resonance capacitors may be disposed in parallel to the coils so as to form a parallel resonance circuit.

In the power transmission apparatus of FIG. 1, as illustrated in FIG. 2, the power reception coil 22 overlaps the power transmission coil 13 of the power transmission device 10, and thus power is transmitted to the power reception device 20. In other words, if an AC current flows through the power transmission coil 13, a magnetic field is generated in the power transmission coil 13. Meanwhile, an AC current flows through the power reception coil 22 due to an electromagnetic coupling action, and power can be obtained by rectifying the current.

In FIG. 2, the power transmission device 10 includes a casing 15 which is a plate-shaped main body on which the power reception device 20 is placed, and the power transmission coil 13 is disposed in the casing 15. In addition, the power reception device 20 includes a casing 26 which is a plate-shaped main body, and may be placed on the power transmission device 10. The power reception coil 22 is disposed in the casing 26 of the power reception device 20 so as to face the power transmission coil 13.

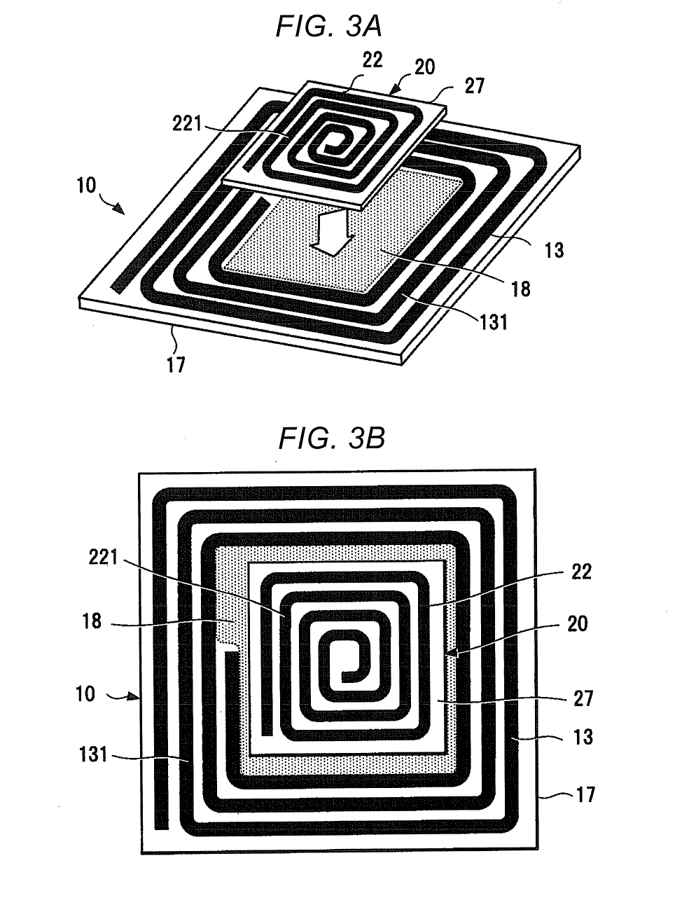

FIG. 3A is a perspective view schematically illustrating a coil device including the power transmission coil 13 and the power reception coil 22, and FIG. 3B is a plan view in which the power transmission coil 13 and the power reception coil 22 are viewed from the top. The power transmission coil 13 is constituted by, for example, a square coil pattern 131 formed on a print board 17. A central region 18 of the power transmission coil 13 is a blank region in which there is no coil pattern 131, and the coil pattern 131 is formed by a planar pattern of several turns (about three turns in the example of FIGS. 3A and 3B) at a peripheral portion of the blank region 18.

On the other hand, the power reception coil 22 is constituted by, for example, a square planar coil pattern 221 which is provided so as to correspond to the blank region 18, has an exterior size which is approximately the same as or smaller than the size of the blank region 18, and is formed on a print board 27.

The power transmission coil 13 is provided along an upper surface inside the casing 15, and the power reception coil 22 is provided along a lower surface inside the casing 26. If power is to be transmitted from the power transmission coil 13 to the power reception coil 22 in a noncontact manner, the power transmission coil 13 is disposed so as to be as close to the power reception coil 22 as possible. In addition, the power transmission coil 13 and the power reception coil 22 are not only constituted by coil patterns formed on a print board or a flexible board, but may also be constituted by planar coils of winding copper wires or litz wires.

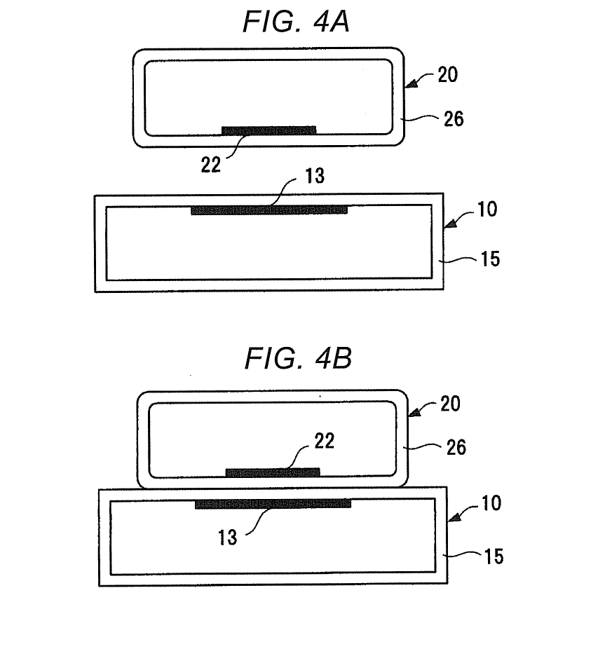

FIGS. 4A and 4B are cross-sectional views of the power transmission device 10 and the power reception device 20. FIG. 4A illustrates a state in which the casing 26 of the power reception device 20 is placed over the casing 15 of the power transmission device 10. FIG. 4B illustrates a state in which the casing 26 of the power reception device 20 is directly placed on the casing 15 of the power transmission device 10, and the power transmission coil 13 and the power reception coil 22 have the shortest distance there between and are thus the closest to each other.

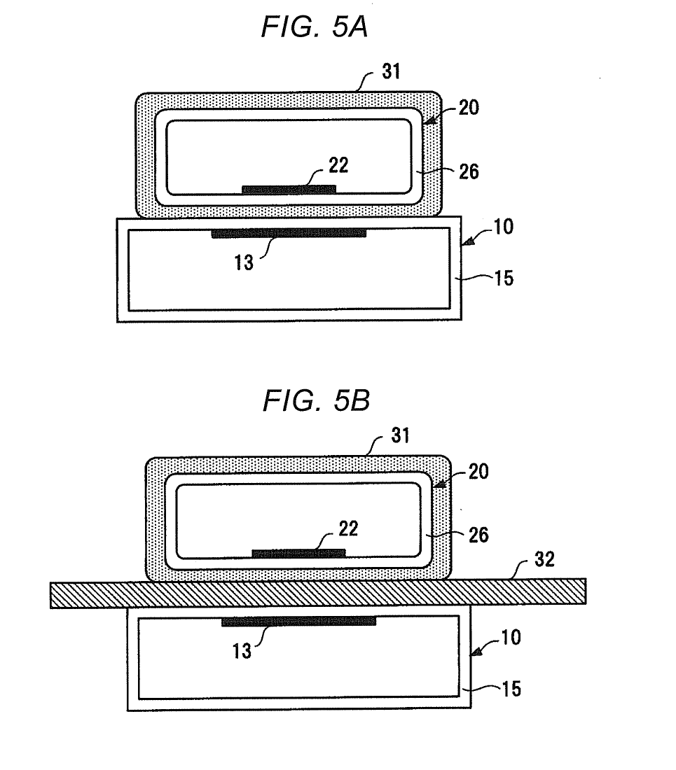

FIGS. 5A and 5B are cross-sectional views illustrating another example of the power transmission device 10 and the power reception device 20. FIG. 5A illustrates a case where, for example, the casing 26 of the power reception device 20 is put into a cover 31 for the purpose of protection or the like. A distance between the power transmission coil 13 and the power reception coil 22 is further lengthened by a thickness of the cover 31 than in FIG. 4B. Although there are various thicknesses of the cover 31, the cover 31 may be 5 mm thick, for example, assuming that the power reception device 20 is a portable terminal, a tablet terminal, or the like.

FIG. 5B illustrates a case where a portable terminal, a tablet terminal, or the like is carried in a bag, and is placed on the casing 15 of the power transmission device 10 so as to be charged in a state of being put into the bag 32. A distance between the power transmission coil 13 and the power reception coil 22 increases by thicknesses of the cover 31 and the bag 32. It is expected that a distance is about 10 mm to 20 mm longer than in FIG. 4B.

In a general power transmission coil, that is, a power transmission coil in which there is no blank region 18, and a coil is wound up in the vicinity of a central portion, if a distance between a power transmission coil and a power reception coil varies only by several mm, a coupling coefficient k between the coils considerably varies, and thus the power which can be transmitted also notably fluctuates. In contrast, in the first embodiment, even if a distance between the power transmission coil 13 and the power reception coil 22 varies, the coupling coefficient k hardly varies.

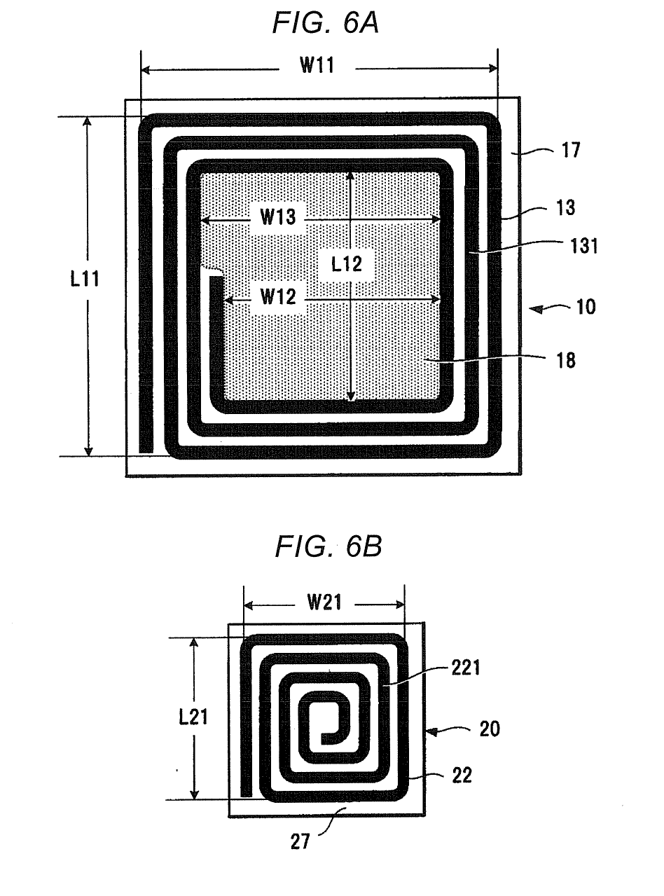

FIGS. 6A and 6B are plan views illustrating a specific shape and an example of dimensions of the coil device according to the first embodiment. As illustrated in FIG. 6A, the power transmission coil 13 includes the coil pattern 131 formed on the print board 17, and an exterior of the power transmission coil 13 has a square shape of L11=W11=157 mm. A coil pattern width is 7 mm, a gap between adjacent coil patterns is 3 mm, and the coil pattern has a shape which is turned about three times. An inductance value is about 2.3 μH.

Dimensions of the blank region 18 at the central portion of the power transmission coil 13 are W12=93 mm, W13=103 mm, and L12=103 mm, and an area of the blank region 18 is (L12/2)×W12+(L12/2)×W13=10094 mm².

An exterior area of the power transmission coil 13 is L11×W11=157×157=24649 mm², and a proportion of the blank region to the entire power transmission coil is 10094/24649×100=40.950 (≅40%).

FIG. 6B is a diagram illustrating a specific shape and an example of dimensions of the power reception coil 22. The power reception coil 22 includes the coil pattern 221 formed on the print board 27, and an exterior of the power reception coil 22 has a square shape of L21=W21=65 mm. A coil pattern width is 5 mm, a gap between adjacent coil patterns is 2.5 mm, and the coil pattern has a shape which is turned about four times. An inductance value is about 0.65 μH.

An area of the power reception coil 22 is L21×W21=65×65=4225 mm², and is smaller than the area of the blank region 18 of the power transmission coil 13. In addition, the area of the power reception coil 22 is not necessarily required to be smaller than the area of the blank region 18, and may be the same as or slightly larger than the area of the blank region 18.

Next, an operation of the power transmission apparatus according to the first embodiment will be described. As for a positional relationship between the power transmission coil 13 and the power reception coil 22 illustrated in FIGS. 6A and 6B, if the power reception device 20 which is a portable terminal or a tablet terminal and a charged side is directly placed on the power transmission device 10 which is a charging cradle, a distance between the power transmission coil 13 and the power reception coil 22 is the shortest as illustrated in FIG. 4B. If the cover 31 is attached in order to carry or protect the casing 26 of the power reception device 20 as illustrated in FIG. 5A, or is placed on the power transmission device 10 in a state of being put into the bag 32 as illustrated in FIG. 5B, a distance between the power transmission coil 13 and the power reception coil 22 is lengthened.

In the related art, if a distance between the power transmission coil and the power reception coil varies, a coupling coefficient k varies. Thus, as long as impedance is not controlled, an amount of power which can be received by the power reception device 20 or power transmission efficiency also varies. In circumstances in which the impedance is not controlled, there is a characteristic in which an amount of power which can be received at a certain distance is the maximum, and an amount of power which can be received is reduced if a distance is shortened or lengthened.

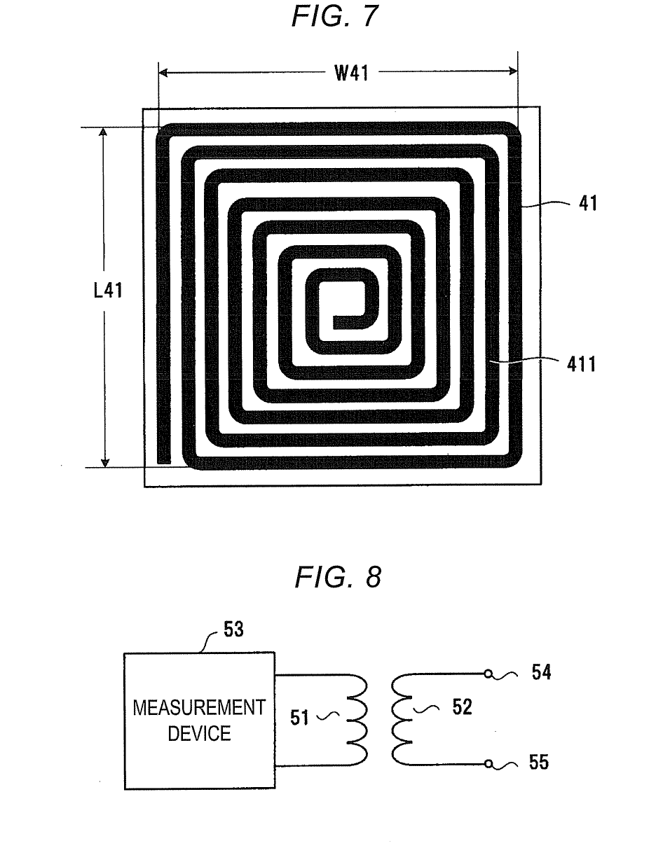

FIG. 7 is a view illustrating a specific shape and an example of dimensions of a general power reception coil 41. Exterior sizes are L41=W41=157 mm, and are the same as the sizes of the power transmission coil 13 of the embodiment. In addition, a pattern width and a gap between adjacent coil patterns are also the same as the pattern width and the gap of the power transmission coil 13, and there is a difference in that a coil pattern 411 is wound up to a central portion.

Here, in a combined case of the power transmission coil 13 and the power reception coil 22 of the embodiment, and a combined case of the power transmission coil 41 and the power reception coil 22 of the related art, variations in the coupling coefficient k are compared with each other when a distance between the coils varies.

The coupling coefficient k may be obtained according to Equation (1) by actually measuring self-inductance Lopen and leakage inductance Lsc.

$$k = \sqrt{1 - \frac{Lsc}{Lopen}} \qquad ( 1 )$$

FIG. 8 is a diagram illustrating a measurement system of the coupling coefficient k in the power transmission apparatus. As illustrated in FIG. 8, one coil 51 is connected to a measurement device 53 such as an LCR meter, and the self-inductance Lopen is measured with the measurement device 53 when both ends 54 and 55 of the other coil 52 are opened, and the leakage inductance lsc is measured with the measurement device 53 when both ends 54 and 55 are short-circuited, thereby obtaining the coupling coefficient k according to Equation (1).

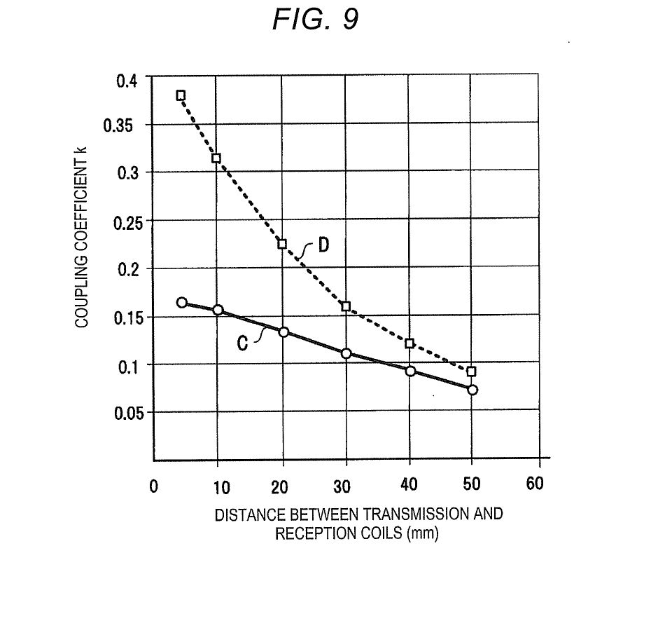

FIG. 9 is a diagram illustrating a characteristic of the coupling coefficient k when a distance between the power transmission coil and the power reception coil (a distance between transmission and reception coils) varies. A solid line C of FIG. 9 indicates a characteristic when the power transmission coil 13 and the power reception coil 22 of the embodiment are used, and a dotted line D indicates a characteristic when the power transmission coil 41 and the power reception coil 22 of FIG. 7 are used.

If the power transmission coil 13 of the embodiment is used, when a distance between the power transmission coil 13 and the power reception coil 22 (a distance between the transmission and reception coils) varies from 5 mm to 50 mm, the coupling coefficient k smoothly is reduced. In contrast, if the power transmission coil 41 is used, a variation rate of the coupling coefficient k increases as a distance between the power transmission coil 41 and the power reception coil 22 is shortened, and a variation in the coupling coefficient k is reduced as the distance is lengthened. In addition, it can be seen that the coupling coefficient k in the case where the power transmission coil 41 is used is similar to the coupling coefficient k of the embodiment if a distance between the transmission and reception coils is lengthened up to about 50 mm.

However, in charging an apparatus in practice, a distance between the transmission and reception coils is often equal to or less than about 20 mm. Therefore, if a variation rate of the coupling coefficient k is calculated when a distance between the transmission and reception coils varies from 5 mm to 20 mm, the variation rate is 0.136/0.165=0.824 in the embodiment (solid line C). In other words, a value of the coupling coefficient k at a distance between the transmission and reception coils of 20 mm is about 82% of a value of a distance between the transmission and reception coils of 5 mm.

In contrast, in the characteristic D indicated by the dotted line, if a variation rate of the coupling coefficient k is calculated when a distance between the transmission and reception coils varies from 5 mm to 20 mm, the variation rate is 0.224/0.375=0.597, and thus a value of the coupling coefficient k at a distance between the transmission and reception coils of 20 mm is reduced to about 60% of a value of a distance between the transmission and reception coils of 5 mm.

As mentioned above, if the power transmission coil 13 of the embodiment is used, a variation in the coupling coefficient k can be smoothened with respect to a variation in a distance between the transmission and reception coils. As a result, an amount of power which can be received or power transmission efficiency slightly varies, and thus complex control such as impedance control is not necessary.

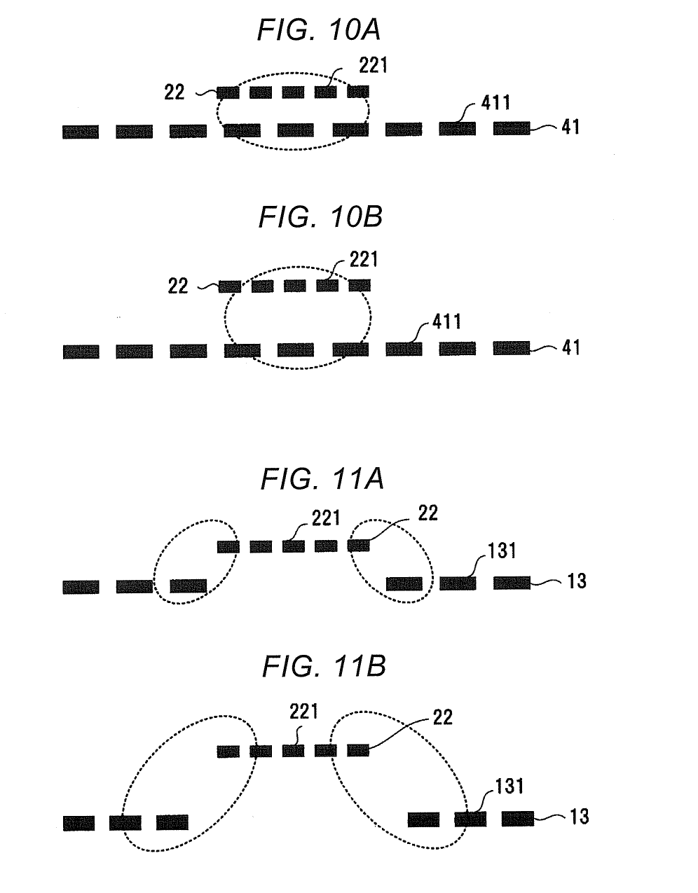

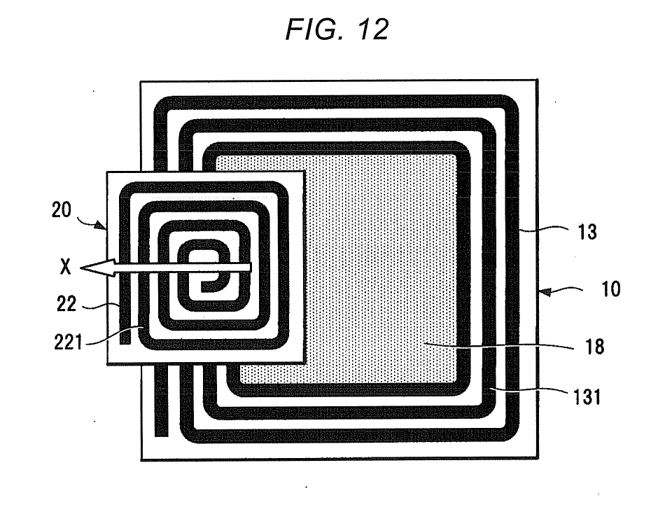

Hereinafter, the reason will be described briefly with reference to FIGS. 10A to 11B. FIGS. 10A and 10B illustrate a case where the power transmission coil 41 (FIG. 7) is used in which the coil pattern 411 is formed up to the vicinity of the central portion, and FIGS. 11A and 11B illustrate a case where the power transmission coil 13 according to the embodiment is used.

First, a case is considered in which the power transmission coil 41 of FIGS. 10A and 10B is used. If the power transmission coil 41 and the power reception coil 22 are close to and face each other as illustrated in FIG. 10A, the mutual coil patterns 411 and 221 are strongly coupled with each other, and thus the coupling coefficient k becomes a high value. In the figures, an elliptical part surrounded by the dotted line schematically indicates a state in which the coils are coupled with each other.

If the power transmission coil 41 and the power reception coil 22 become distant from each other as illustrated in FIG. 10B, the coupling coefficient k decreases further than in a case of FIG. 10A, and is reduced according to distance (refer to FIG. 9). Particularly, as in FIG. 10A, in circumstances in which the coils are strongly coupled with each other, if a distance between the transmission and reception coils only slightly varies, the coupling coefficient k tends to considerably vary.

On the other hand, if the power transmission coil 13 is used, when the power transmission coil 13 and the power reception coil 22 are located close to each other as illustrated in FIG. 11A, there is no coil pattern 131 of the power transmission coil 13 at a position facing the power reception coil 22. The coil pattern 131 and the coil pattern 221 are mainly coupled at edge portions of the coils as illustrated in a dotted ellipse of FIG. 11A, and thus coupling therebetween is not strong, and, as a result, the coupling coefficient k is not a great value even if the coils are close to each other.

In addition, if the power transmission coil 13 and the power reception coil 22 become distant from each other as illustrated in FIG. 11B, coupling mainly occurs at the edge portions of the coils as illustrated in a dotted ellipse of FIG. 11B, but an area of the coil pattern which contributes the coupling is qualitatively larger than an area when the coils are close to each other in FIG. 11A. In other words, a reduction in the coupling due to an increase in a distance between the coils can be canceled out to some degree by an increase in an area of the coil pattern contributing to the coupling. As a result, if a distance between the transmission and reception coils is lengthened, the coupling coefficient k tends to decrease, but a variation therein is smooth as indicated by the solid line C of FIG. 9.

As described above, description was made of a case where a distance between the power transmission coil 13 and the power reception coil 22 varies, but a variation in a coupling coefficient can be made small even if a position of the power reception coil 22 varies along the power transmission coil 13.

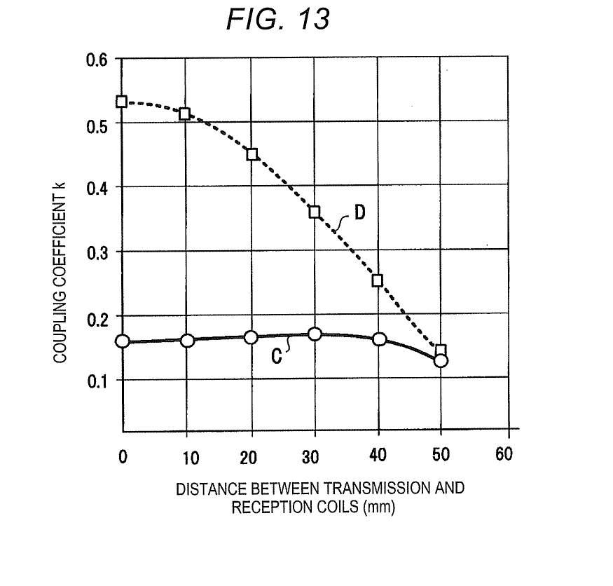

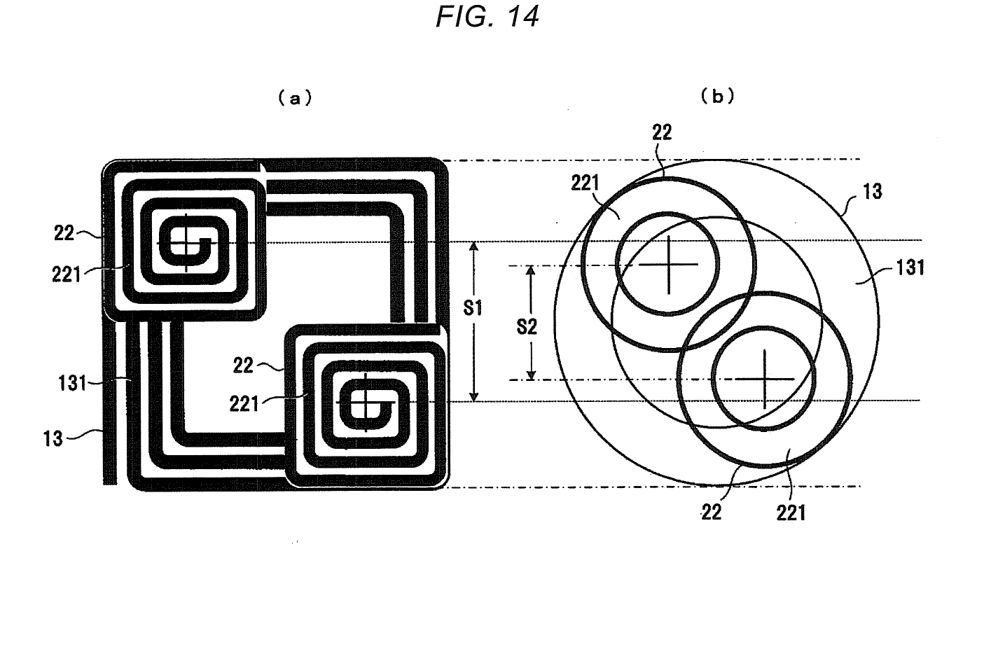

FIG. 12 illustrates a case in which the power reception coil 22 illustrated in FIGS. 3A and 3B is moved in a direction of an arrow X along the power transmission coil 13. In addition, a solid line C of FIG. 13 indicates a variation characteristic of the coupling coefficient k when the power reception coil 22 is moved in the arrow X direction. Further, a dotted line D of FIG. 13 indicates a variation characteristic of the coupling coefficient k for comparison when the coil 41 illustrated in FIG. 7 in which the coil pattern is present up to the central portion is used as a power transmission coil and a coil of a power reception side. The coil 41 used for comparison is wound about six times, and an inductance value thereof is about 1.5 μH.

In FIG. 13, an amount in which the power reception coil 22 is moved along the power transmission coil 13 is referred to as a horizontal direction deviation amount. In a comparative example (the dotted line D), a facing area between the power transmission side coil and the power reception side coil is reduced as the horizontal direction deviation amount increases, and thus the coupling coefficient k is considerably reduced. In contrast, in an example (the solid line C) of the embodiment, the coupling coefficient k does not almost vary up to a deviation amount of 40 mm, and the coupling coefficient k is slightly reduced even in a deviation amount of about 50 mm.

The reason may be that a variation in an area of the power transmission coil and the power reception coil contributing to coupling is small even if the power reception coil 22 is moved along the power transmission coil 13. In the embodiment, a variation in the coupling coefficient k can be made small in a range in which the power reception coil 22 does not protrude from the power transmission coil 13.

In addition, in the embodiment, the power transmission coil 13 and the power reception coil 22 were described to have a substantial square shape as an example, but are not necessarily limited to the square shape, and may have a quadrangular shape such as a rectangular shape, or other polygonal shapes (a hexagonal shape, an octagonal shape, and the like). A circular shape may be used, but a polygonal shape is preferably used in consideration of an allowable amount when the power reception coil 22 is moved along the power transmission coil 13.

FIG. 14A illustrates a case where the power transmission coil 13 and the power reception coil 22 are formed in a square shape, and FIG. 14B illustrates a case where the power transmission coil 13 and the power reception coil 22 are formed in a circular shape. As illustrated in FIG. 14A, in the square shape, even if a position of the power reception coil 22 is shifted to a diagonal corner position of the power transmission coil 13, a characteristics is obtained in which the pattern 221 of the power reception coil 22 does not protrude from the pattern 131 of the power transmission coil 13, and the coupling coefficient k does not almost vary.

In contrast, in the circular shape, a position at which the pattern 221 of the power reception coil 22 does not protrude from the pattern 131 of the power transmission coil 13 is a position illustrated in FIG. 14B. When central positions (cross) of the power reception coil 22 at this time are compared in the square shape and the circular shape, it can be seen that the cross comes near the center of the power transmission coil 13 in the circular shape. In other words, a movable distance is S1 in the square shape, and is S2 (S1>S2) in the circular shape. As mentioned above, if the square coil and the circular coil with the same maximum exterior dimension are compared as the power transmission coil 13, using the square coil enables an allowable range of positional deviation of the power reception coil 22 to be wider.

In addition, numerical values such as the coil dimensions described in the embodiment are only an example, and are not limited to the numerical values. Further, a proportion of the blank region 18 relative to the entire power transmission coil was described to be about 40%, but is not limited to 40%, and may be in a range of, for example, 30% to 50% which can achieve the same effect.

### Second Embodiment

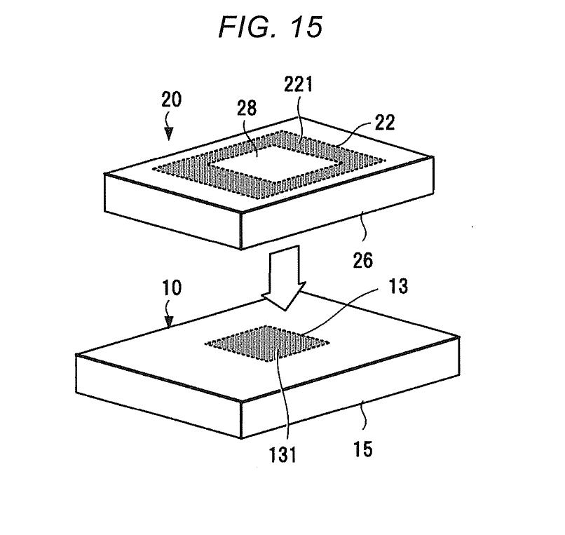

A second embodiment will be described with reference to FIG. 15. In the second embodiment, shapes of the power transmission coil 13 of the power transmission device 10 and the power reception coil 22 of the power reception device 20 are changed with each other. In other words, the power reception coil 22 is constituted by, for example, the coil pattern 221 formed on a print board, and a central region 28 is a blank region in which there is no coil pattern. The coil pattern 221 is provided at a peripheral portion of the blank region 28 and is formed by a pattern of several turns from an outer edge portion.

On the other hand, the power transmission coil 13 is constituted by, for example, the coil pattern 131 which has a size which is approximately the same as or smaller than the size of the blank region 28 and is formed on a print board. The power transmission coil 13 is provided along an upper surface inside the casing 15, and the power reception coil 22 is provided along a lower surface inside the casing 26. In addition, if power is to be transmitted from the power transmission coil 13 to the power reception coil 22 in a noncontact manner, the power transmission coil 13 is preferably disposed so as to be as close to the power reception coil 22 as possible.

Also in the second embodiment, the coupling coefficient k hardly varies even if a distance between the power transmission coil 13 and the power reception coil 22 varies.

As the power reception device 20, for example, there is a battery device, an adaptor, or a terminal main body. In the battery device, the coil 22 and the rectifying circuit 24 are provided in the device, a charging circuit and a battery are integrally formed as the load circuit 25, and the battery can be charged by placing the battery device on a charging cradle (the power transmission device 10). In the adaptor, a coil and a rectifying circuit are integrally formed as an adaptor, and a terminal main body and the adaptor are connected to each other for use. In addition, if the power reception device 20 is a terminal main body, a coil and a rectifying circuit are provided inside the terminal and are integrally formed with the terminal. Examples of the terminal include a mobile phone, a smart phone, a handy terminal for use only in a restaurant, a mobile printer, a thermal printer, a tablet, a notebook PC, and the like.

According to the embodiments described above, a power transmission apparatus can be provided which can minimize a variation in the coupling coefficient k even if a distance between the resonance elements of the power transmission device 10 and the power reception device 20 varies, and thus is not required to control impedance, and can maintain high power transmission efficiency.

Several embodiments of the invention have been described, but the embodiments are only an example, and are not intended to limit the scope of the invention. The embodiments can be implemented in other various forms, and various omissions, modifications, and alterations may occur within the scope without departing from the spirit of the invention. The embodiments and the modifications thereof are included in the invention recited in the claims and the equivalents thereof as being included in the scope or the spirit of the invention.

What is claimed is:

1. A power transmission apparatus comprising:
a power transmission device that transmits power in a noncontact manner through electromagnetic coupling; and
a power reception device that receives the power,
wherein the power transmission device includes
a power transmission coil; and
an AC power source that supplies AC power to a resonance element including the power transmission coil,
wherein the power reception device includes
a power transmission coil that receives power; and
a rectifying circuit that rectifies AC power induced in the a resonance element including the power reception coil,
wherein one of the power transmission coil and the power reception coil includes a blank region that is formed at a central portion, and a first coil pattern that is formed in a planar shape at a peripheral portion of the blank region, and
wherein the other of the power transmission coil and the power reception coil includes a second coil pattern which is formed in a planar shape so as to correspond to the blank region.

2. The apparatus according to claim 1, wherein the second coil pattern has an exterior dimension which is the same as or smaller than a dimension of the blank region.

3. The apparatus according to claim 1, wherein the first coil pattern and the second coil pattern are formed on boards.

4. The apparatus according to claim 1, wherein an area of the blank region is 30% to 50% of an exterior area of the first coil pattern.

5. A power transmission device which transmits power to a power reception device in a noncontact manner through electromagnetic coupling, the power transmission device comprising:
a blank region that is formed at a central portion; and
a first coil pattern that is formed in a planar shape at a peripheral portion of the blank region.

6. A power reception device which receives power from a power transmission device in a noncontact manner through electromagnetic coupling, the power reception device comprising:
a blank region that is formed at a central portion; and
a first coil pattern that is formed in a planar shape at a peripheral portion of the blank region.

7. A coil device for a power transmission apparatus which transmits power from a power transmission coil to a power reception coil in a noncontact manner through electromagnetic coupling, the device comprising:
the power transmission coil; and
the power reception coil,
wherein one of the power transmission coil and the power reception coil includes a blank region that is formed at a central portion, and a planar coil pattern that is formed in a polygonal shape at a peripheral portion of the blank region.
